(19) United States
(12) Patent Application Publication
(10) Pub. No.: US 2026/0147179 A1
(43) Pub. Date: May 28, 2026

(54) CAMERA FOR VEHICLE, AND VEHICLE

(71) Applicant: LG INNOTEK CO., LTD., Seoul (KR)

(72) Inventor: Sang Yeal HAN, Seoul (KR)

(21) Appl. No.: 19/114,563

(22) PCT Filed: Sep. 22, 2023
(86) PCT No.: PCT/KR2023/014542

§ 371 Date: Mar. 24, 2025

(30) Foreign Application Priority Data
Sep. 23, 2022 (KR) 10-2022-0121097
Sep. 23, 2022 (KR) 10-2022-0121098

(51) Int. Cl. G02B 7/02; G03B 17/55

(52) U.S. Cl. CPC G02B 7/028; G03B 17/55

(57) ABSTRACT

This camera module comprises: a lens barrel; a lens disposed in the lens barrel; a heating member including a heating unit disposed on the surface of the lens; and a sensor member including a sensor unit disposed on the bottom surface of the heating unit, wherein the lens includes a groove to which the heating unit and the sensor unit are coupled.

### TECHNICAL FIELD

The present embodiment relates to a vehicle camera and a vehicle.

### BACKGROUND ART

Recently, ultra-small camera modules have been developed and are widely used in small electronic products such as smartphones, laptops, and game consoles.

As automobiles become more popular, ultra-small cameras are widely used in vehicles as well as in small electronic products. For example, black box cameras for vehicle protection or objective data on traffic accidents, rear surveillance cameras that allow drivers to monitor the blind spots at the rear of the vehicle through a screen to ensure safety when reversing, and surrounding detection cameras that can monitor the surroundings of the vehicle are provided.

The camera may be equipped with a lens, a lens holder that accommodates the lens, an image sensor that converts an image of a subject collected in the lens into an electrical signal, and a printed circuit board on which the image sensor is mounted. The housing forming the outer appearance of the camera is formed with a structure in which the entire area is sealed to prevent internal components from being contaminated by foreign substances containing moisture.

In the case of a camera module, since it is disposed outside the vehicle and is greatly affected by outside air, frost, condensation, and freezing frequently occur in the lens in winter. When frost, condensation, and freezing occur in the lens, there is a problem in that the performance of the camera module is greatly deteriorated.

### DETAILED DESCRIPTION OF THE INVENTION

### Technical Subject

The present embodiment is intended to provide a camera module and a vehicle capable of quickly removing frost or ice generated on the surface of a lens through a heating function.

### Technical Solution

A camera module according to the present embodiment comprises: a lens barrel; a lens being disposed inside the lens barrel; a heating member including a heating unit being disposed on a surface of the lens; and a sensor member including a sensor unit being disposed on a lower surface of the heating unit, wherein the lens includes a groove to which the heating unit and the sensor unit are coupled.

The heating unit may be a positive temperature coefficient (PTC) ink being applied to the surface of the lens.

The heating unit may have a black color.

Each of the heating unit and the sensor unit may have a ring-shaped cross-section.

A temperature sensor may be disposed on a lower surface of the sensor unit.

The heating unit and the sensor unit may be interposed between an upper surface of the lens barrel and a lower surface of the lens.

A rib being protruded downward may be disposed on a lower surface of the sensor unit

The heating member includes a first connecting portion having one end connected to the heating unit and the other end connected to a printed circuit board, and the sensor member includes a second connecting portion having one end connected to the sensor unit and the other end connected to the printed circuit board, and the first connecting portion and the second connecting portion can be disposed to be overlapped with at least a portion thereof.

The first connecting portion and the second connecting portion may be flexible printed circuit boards (FPCBs).

According to another embodiment, a camera module comprises: a first body; a lens module being disposed inside the first body, the lens module including a lens barrel and a lens being disposed inside the lens barrel; a printed circuit board being disposed inside the first body; and a heating member providing heat to the lens, wherein the heating member may include a heating unit being disposed on a surface of the lens, and a substrate electrically connecting the heating unit and the printed circuit board.

### Advantageous Effects

Through the present embodiment, since the surface of the lens is heated based on information detected by the temperature sensor, not only can frost or ice being formed on a surface of the lens can be efficiently removed, but there is also an advantage in that power can be efficiently managed.

### BRIEF DESCRIPTION OF DRAWINGS

FIG. 1 is a perspective view of a vehicle according to an embodiment of the present invention.

FIG. 2 is a perspective view illustrating the outer appearance of a camera module according to a first embodiment of the present invention.

FIG. 3 is a cross-sectional view of a camera module according to a first embodiment of the present invention.

FIG. 4 is a perspective view of a lens barrel according to a first embodiment of the present invention.

FIG. 5 is a cross-sectional view illustrating a coupling structure of a first lens, a heating member, and a sensor member according to a first embodiment of the present invention.

FIG. 6 is an exploded perspective view of a first lens, a heating member, and a sensor member according to a first embodiment of the present invention.

FIG. 7 is a perspective view illustrating a coupling structure of a first lens, a heating member, and a sensor member according to a first embodiment of the present invention.

FIG. 8 is a cross-sectional view of a camera module according to a second embodiment of the present invention.

FIG. 9 is a cross-sectional view of a lens heat generation structure according to a second embodiment of the present invention.

FIG. 10 is a plan view of a substrate according to a second embodiment of the present invention.

FIG. 11 is a cross-sectional view of a lens heat generation structure according to a third embodiment of the present invention.

FIG. 12 is a perspective view of a camera module according to a fourth embodiment of the present invention.

FIG. 13 is a cross-sectional view of a camera module according to a fourth embodiment of the present invention.

FIG. 14 is a cross-sectional view of a first lens according to a fourth embodiment of the present invention.

FIG. 15 is a perspective view of a lens barrel according to a fourth embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or disposed in “on (above)” or “below (under)” of each component, “on (above)” or “below (under)” means that it includes not only the case where the two components are directly in contact with, but also the case where one or more other components are formed or disposed between the two components. In addition, when expressed as “on (above)” or “below (under)”, the meaning of not only an upward direction but also a downward direction with respect to one component may be included.

The ‘optical axis direction’ used hereinafter is defined as the optical axis direction of the lens. Meanwhile, the ‘optical axis direction’ may correspond to ‘up-down direction’, ‘z-axis direction’, and the like.

Hereinafter, the present invention will be described in more detail with reference to the attached drawings.

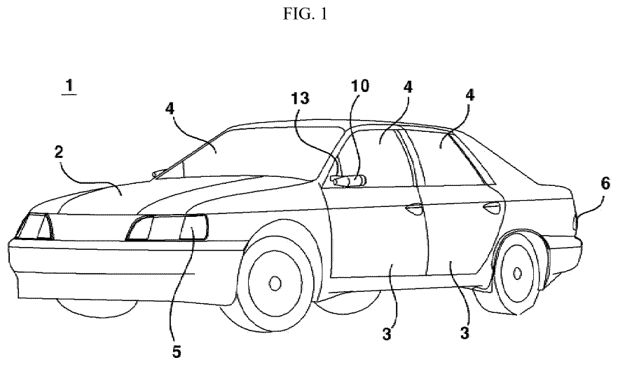

FIG. 1 is a perspective view of a vehicle according to an embodiment of the present invention.

Referring to FIG. 1, a vehicle 1 according to an embodiment of the present invention may include a body 2, a door 3, glass 4, a headlamp 5, a tail lamp 6, and a camera module 10.

The body 2 may be an exterior member of the vehicle 1. The body 2 may have various forms, such as a frame type and a monocoque type. One or more doors 3 may be coupled to a side surface of the body 2. In addition, the glass 4 may be coupled to the front and rear a portion where a pillar is formed of the upper portion of the body 2 and the door 3. The headlamp 5 may be mounted on the front of the lower portion of the body 2. The tail lamp 6 may be mounted on the rear of the lower portion of the body 2.

A camera module 10 may be installed on a side portion of the body 2 or on a door being disposed at the front of one or more of the doors 3. The camera module 10 may be installed in front of the glass 4 coupled to the door 3. That is, a side mirror in the vehicle 1 of the present embodiment may be redisposed with the camera module 10.

The above camera module 10 can photograph images of both rear sides of the vehicle. Images photographed by the camera module 10 can be electrically connected to a display unit (not shown) through an electronic control unit (ECU), and the like. Accordingly, images photographed by the camera module 10 can be controlled by the electronic control unit (ECU) and played back on the display unit.

An interior space for a driver can be formed inside the body 2. A display unit can be installed inside the body 2. The display unit can output an image photographed by the camera module 10. The display unit can be installed on a dashboard (not shown) inside the body 2.

The installation form of the camera module 10 inside the vehicle 1 described above is exemplary, and the camera module 10 can be used in one or more among a front camera, a side camera, a rear camera, and a black box of the vehicle 1.

Hereinafter, a camera module according to a first embodiment is described with reference to the drawings.

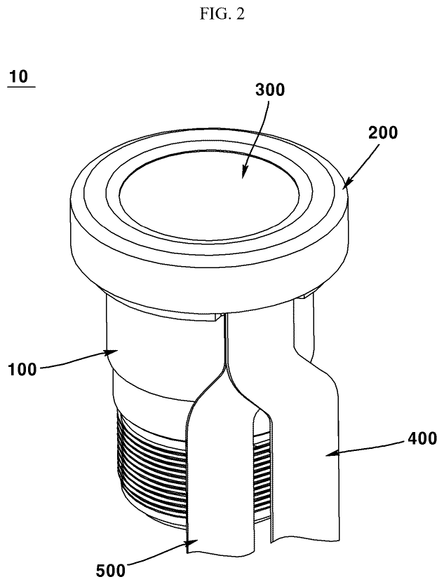

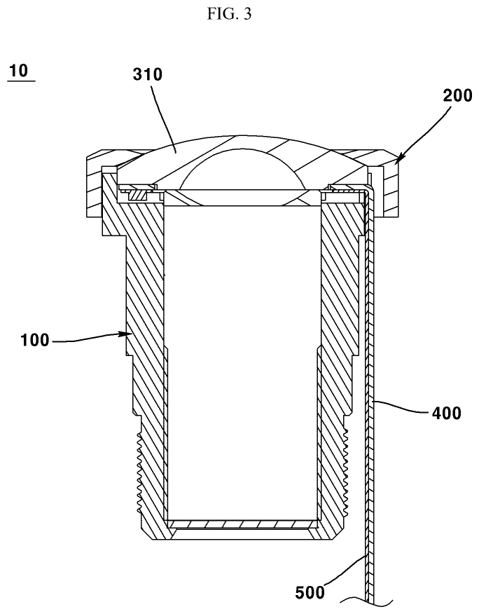

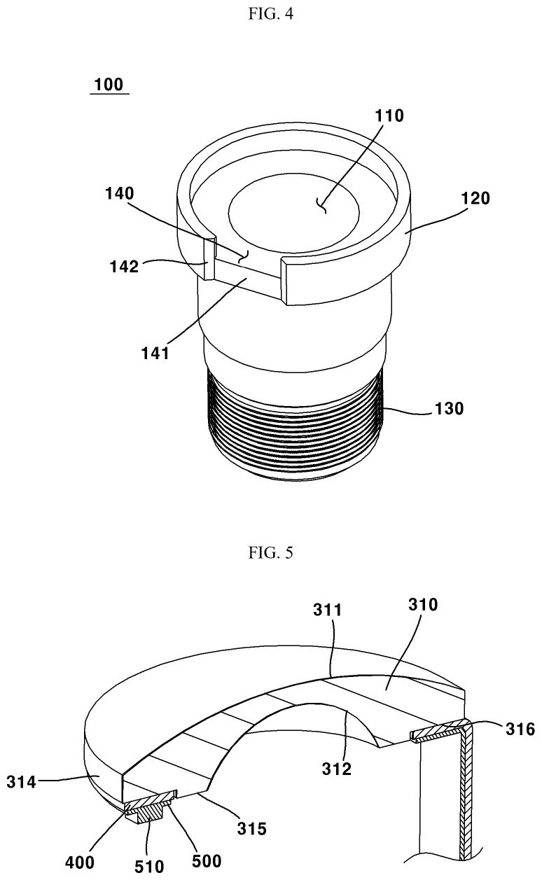

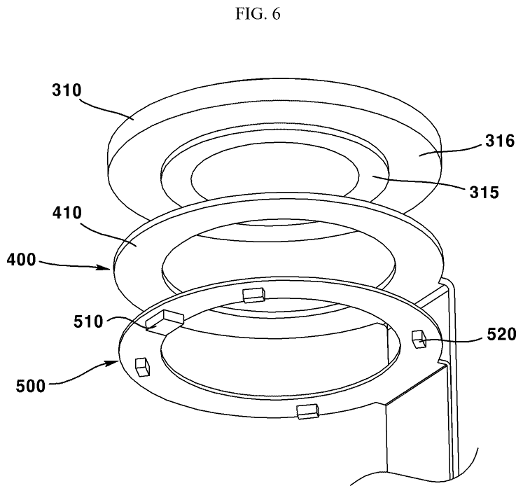

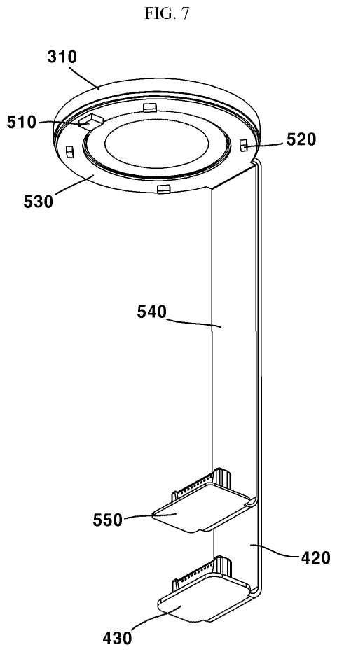

FIG. 2 is a perspective view illustrating the outer appearance of a camera module according to a first embodiment of the present invention; FIG. 3 is a cross-sectional view of a camera module according to a first embodiment of the present invention; FIG. 4 is a perspective view of a lens barrel according to a first embodiment of the present invention; FIG. 5 is a cross-sectional view illustrating a coupling structure of a first lens, a heating member, and a sensor member according to a first embodiment of the present invention; FIG. 6 is an exploded perspective view of a first lens, a heating member, and a sensor member according to a first embodiment of the present invention; and FIG. 7 is a perspective view illustrating a coupling structure of a first lens, a heating member, and a sensor member according to a first embodiment of the present invention.

Referring to FIGS. 2 to 7, a camera module 10 according to a first embodiment of the present invention may include a lens barrel 100, a retainer 200, a lens 300, a heating member 400, and a sensor member 500.

The lens barrel 100 may be formed in a cylindrical shape with the upper and lower surfaces open. A space 110 in which the lens 300 is disposed may be formed inside the lens barrel 100. The space 110 of the lens barrel 100 may include a plurality of regions with different cross-sectional areas. For example, the region in which a first lens 310 to be described later is disposed among the spaces inside the lens barrel 100 may be formed to have a larger cross-sectional area than other regions.

The camera module 10 may include a body (not shown) that forms the outer appearance of the camera module 10 and has the lens barrel 100 disposed therein. The body may include a front body and a rear body. A hole into which the lens barrel 100 is coupled is formed in the front of the front body, and at least a portion of the lens barrel 100 may be disposed to be protruded from the outer surface of the front body.

A screw coupling portion 130 for coupling with the front body or other components inside the front body may be formed on the outer circumferential surface of the lens barrel 100.

The lens barrel 100 may include a plurality of regions having different cross-sectional areas. For example, the lens barrel 100 may include a first region and a second region being disposed at a lower portion of the first region. The cross-sectional area of the first region may be formed to be larger than the cross-sectional area of the second region. The retainer 200 may be disposed on the outside of the first region. The retainer 200 may be coupled to the outer surface of the lens barrel 100 through an adhesive or may be screw-coupled through screw threads.

A protruded portion 120 being protruded upwardly and supporting a side surface of a first lens 310 to be described later may be formed on the upper surface of the lens barrel 100. A portion of the side surface of the first lens 310 may be covered by the protruded portion 120. The inner surface of the protruded portion 120 may come into contact with the side surface of the first lens 310.

An avoidance portion 140 may be formed on the side surface of the lens barrel 100. The avoidance portion 140 may have a groove shape being recessed inward more than other regions. The avoidance portion 140 may be formed on the side surface of the first region where the outermost lens 310 is disposed. The avoidance portion 140 may have a shape that is obtained by cutting the formation region of the protruded portion 120 by a predetermined distance in a circumferential direction. When viewed from the side surface, the avoidance portion 140 may have a hole shape that penetrates a portion of the protruded portion 120 in a direction perpendicular to the optical axis direction. The side of the first region corresponding to the formation region of the avoidance portion 140 may be flat. At least a portion of the heating member 400 and the sensor member 500 may be disposed on the avoidance portion 140. The above avoidance portion 140 may include a bottom surface 141 and a plurality of guide surfaces 142 being disposed on both sides of the bottom surface 141. The guide surfaces 142 may be disposed to form an obtuse angle with the bottom surface 141.

The lens 300 may be disposed inside the lens barrel 100. The lenses 300 may be provided in multiple numbers and may be disposed spaced apart from each other based on the optical axis direction. The lens 300 may include a first lens 310 and a second lens being disposed at a lower portion of the first lens 310. The first lens 310 and the second lens may be spaced apart from each other. In the space 110 inside the lens barrel 100, the cross-sectional areas of the regions where the first lens 310 and the second lens are disposed may be different. The first lens 310 may be referred to as an outermost lens. The first lens 310 may be formed to have a larger cross-sectional area than other lenses. The incident surface of the first lens 310 may be protruded upwards more than the upper surface of the lens barrel 100 or the upper surface of the retainer 200.

The first lens 310 may include an incident surface 311 through which light is incident, an exit surface 312 through which the incident light is emitted, and a connecting surface connecting the incident surface 311 and the exit surface 312. The connecting surface may include a first connecting surface 314 and a second connecting surface 315. The first connecting surface 314 may form a side surface of the first lens 310. The second connecting surface 315 may form a lower surface of the first lens 310. A groove 316 having a shape being recessed upward more than other regions may be formed on the lower surface of the first lens 310. The bottom surface of the groove 316 may be disposed with a step in an optical axis direction from the second connecting surface 315. The bottom surface of the groove 316 can be disposed higher than the second connecting surface 315.

The groove 316 may have a ring-shaped cross section.

The retainer 200 may be coupled to an outer surface of the lens barrel 100. The retainer 200 may be coupled to an upper end of the lens barrel 100. At least a portion of the retainer 200 may be disposed inside the front body.

The retainer 200 may have a ring-shaped cross section. At least a portion of the retainer 200 may be disposed to cover an edge of the incident surface 311 of the first lens 310. The retainer 200 may be disposed to surround an edge of the first lens 310. The retainer 200 may be in contact with a portion of the incident surface of the first lens 310.

The heating member 400 may be a positive temperature coefficient heater (PTC).

The heating member 400 may be disposed outside the lens barrel 100. The heating member 400 may have one end being disposed on a surface of the first lens 310 and the other end being coupled to the printed circuit board. The printed circuit board may be disposed inside the body of the camera module 10.

The heating member 400 may include a heating unit 410, a first connecting portion 420, and a first terminal portion 430.

The heating unit 410 may be disposed between an upper surface of the lens barrel 100 and a lower surface of the first lens 310. The heating unit 410 may be disposed in the groove 316. The heating unit 410 may have a cross-sectional shape of a ring shape. An adhesive or an adhesive tape may be disposed between the heating unit 410 and the groove 316.

The heating unit 410 may generate heat. The heating unit 410 may include a positive temperature coefficient (PTC) material, and may be manufactured in the form of a semiconductor device. The heating unit 410 may include a PTC device, an electrode plate, and an insulating plate. The heating unit 410 may include a heating ink applied to a sheet on which a circuit pattern is formed.

Frost, ice, and the like generated on the surface of the first lens 310 can be removed through the heat generated from the heating unit 410.

The heating unit 410 may be black.

The first terminal portion 430 can be coupled with the printed circuit board. A connector being electrically and physically coupled with the first terminal portion 430 can be disposed on the surface of the printed circuit board.

The first connecting portion 420 may be disposed to connect the first terminal portion 430 and the heating unit 410. The first connecting portion 420 may be a flexible printed circuit board (FPCB). The first connecting portion 420 may include a circuit pattern. The first connecting portion 420 may have a region that is bent at least once. The first connecting portion 420 may be disposed on an outside of the lens barrel 100. At least a portion of the first connecting portion 420 may be disposed on the avoidance portion 140. The first connecting portion 420 may be coupled to a side surface of the lens barrel 100 by the bottom surface 141 and the guide surface 142.

The sensor member 500 may be disposed at an inner side of the heating member 400. The sensor member 500 may be disposed so that at least a portion is overlapped with the heating member 400. The sensor member 500 may be disposed so that at least a portion is overlapped with the heating member 400 in a direction perpendicular to the optical axis direction. At least a portion of the sensor member 500 may be coupled to the avoidance portion 140. The sensor member 500 and the heating member 400 may be disposed so as to be overlapped with the avoidance portion 140.

At least a portion of the sensor member 500 and the above heating member 400 may be disposed so as not to be overlapped with each other.

The sensor member 500 may include a sensor unit 530, a second connecting portion 540, and a second terminal portion 550.

The sensor unit 530 may be disposed between the upper surface of the lens barrel 100 and the lower surface of the first lens 310. The sensor unit 530 may be disposed in the groove 316. The sensor unit 530 may be disposed at a lower portion of the heating unit 410. The upper surface of the sensor unit 530 and the lower surface of the heating unit 410 may be in contact. The sensor unit 530 may have a ring-shaped cross-section. An adhesive or adhesive tape may be disposed between the sensor unit 530 and the heating unit 410.

A temperature sensor 510 may be disposed on a lower surface of the sensor unit 530. The temperature sensor 510 may detect the temperature of the heating unit 410 or the first lens 310. The temperature sensor 510 may be mounted on a lower surface of the sensor unit 530. A circuit pattern (not shown) for electrical connection of the temperature sensor 510 may be formed in the sensor unit 530.

A rib 520 may be formed on a lower surface of the sensor unit 530. The rib 520 may have a shape being protruded downward from the lower surface of the sensor unit 530. The strength of the sensor unit 530 may be reinforced through the rib 520. The rib 520 may be in contact with an upper surface of the lens barrel 100. The ribs 520 may be provided in multiple numbers and may be disposed to be spaced apart from each other with respect to a circumferential direction.

The second terminal portion 550 may be coupled with the printed circuit board. A connector being electrically and physically coupled with the second terminal portion 550 may be disposed on a surface of the printed circuit board. The printed circuit board being coupled with the first terminal portion 430 and the printed circuit board being coupled with the second terminal portion 550 may be different. Unlike this, the printed circuit board being coupled with the first terminal portion 430 and the printed circuit board being coupled with the second terminal portion 550 may be the same.

The second connecting portion 540 may be disposed to connect the second terminal portion 550 and the sensor 530. The second connecting portion 540 may be a flexible printed circuit board (FPCB). The second connecting portion 540 may include a circuit pattern. The second connecting portion 540 may have a region that is folded at least once. The second connecting portion 540 may be disposed outside the lens barrel 100. The second connecting portion 540 may be disposed inside the first connecting portion 420. At least a portion of the second connecting portion 540 may be disposed in the avoidance portion 140. The second connecting portion 540 can be connected to the side surface of the lens barrel 100 by the bottom surface 141 and the guide surface 142.

According to the above structure, since the surface of the lens is heated based on information detected through the temperature sensor, not only can frost or ice occurring on the surface of the lens be efficiently removed, but there is also an advantage in that power can be efficiently managed.

Hereinafter, a camera module according to a second embodiment is described with reference to the drawings.

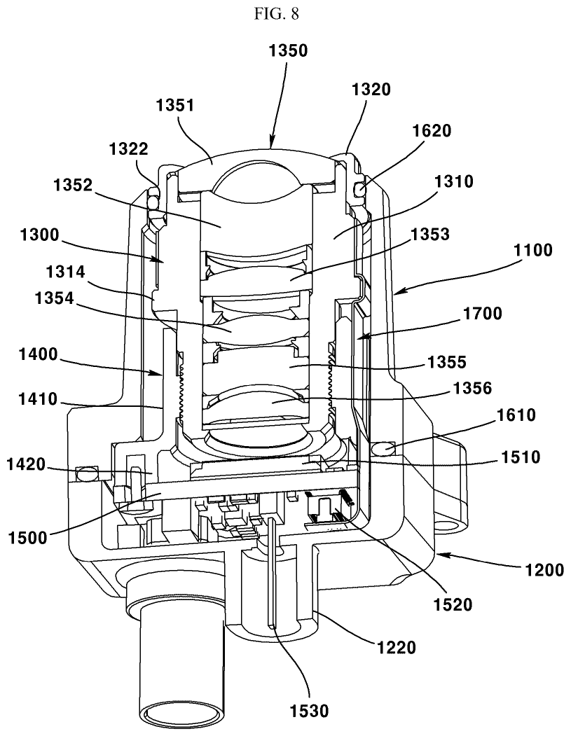

FIG. 8 is a cross-sectional view of a camera module according to a second embodiment of the present invention.

Referring to FIG. 8, a camera module according to an embodiment of the present invention may comprise a first body 1100, a second body 1200, a lens module 1300, a lens holder 1400, a printed circuit board 1500, sealing members 1610 and 1620, and a heating member 1700.

The first body 1100 may form the outer appearance of the camera module. The first body 1100 may be referred to as any one among a front body, an upper housing, and a first housing. A space may be formed inside the first body 1100 so that the lens module 1300, the lens holder 1400, and the printed circuit board 1500 may be disposed.

The second body 1200 can form the outer appearance of the camera module by coupling with the first body 1100. The second body 1200 can be named as any one among a rear body, a lower housing, and a second housing. The second body 1100 can be coupled with the lower surface of the first body 1100. The second body 1200 can be coupled with the first body 1100 by any one of ultrasonic welding, laser welding, and thermal welding. Unlike this, the second body 1200 and the first body 1100 can be mutually coupled by epoxy. An internal space in which the printed circuit board 1500 is disposed can be formed inside the second body 1200. The space inside the first body 1100 and the space inside the second body 1200 can be connected.

A connector withdrawal part 1220 may be formed on a lower surface of the second body 1200 being protruded downward than other regions. A space may be formed inside the connector withdrawal part 1220, such that a pin 1530, which will be described later, is disposed. An external connector is coupled to the connector withdrawal part 1220, and the external connector may include a terminal (not shown) being electrically and physically coupled to the pin 1530.

The lens module 1300 may be disposed inside the first body 1100. At least a portion of the lens module 1300 may be protruded upward from the first body 1100. The lens module 1300 may include a lens barrel 1310, a lens 1350, and a retainer 1320.

The lens barrel 1310 may be disposed inside the first body 1100. The lens barrel 1310 may be formed in a cylindrical shape with open upper and lower surfaces. A space in which the lens 1350 is disposed may be formed inside the lens barrel 1310. The space of the lens barrel 1310 may include a plurality of regions having different cross-sectional areas. For example, a region of the lens barrel 1310 in which a first lens 1351 to be described later is disposed may have a larger cross-sectional area than other regions. At least a portion of the lens barrel 1310 may be disposed inside the lens holder 1400. The lens barrel 1310 may be coupled to the lens holder 1400. The lens barrel 1310 may be screw-coupled to the lens holder 1400.

The lens barrel 1310 may include a plurality of regions having different cross-sectional areas. For example, the lens barrel 1310 may include a first region and a second region being disposed at a lower portion of the first region. A cross-sectional area of the first region may be larger than a cross-sectional area of the second region. The second region may be screw-coupled to the lens holder 1400. A screw thread or a screw groove may be formed in an outer circumferential surface of the second region. The heating member 1700 may be disposed to surround a portion of the outer circumferential surface of the first region.

The lens barrel 1310 may include a protruded portion 1314. The protruded portion 1314 may be disposed between the first region and the second region. The protruded portion 1314 may have a shape in which a portion of an outer circumferential surface of the lens barrel 1310 being protruded outward. The protruded portion 1314 may have a ring-shaped cross section.

The lens 1350 may be disposed inside the lens barrel 1310. A plurality of lenses 1310 may be provided and disposed to be spaced apart from each other with respect to an optical axis direction. The plurality of lenses 1310 may include a first lens 1351, a second lens 1352, a third lens 1353, a fourth lens 1354, a fifth lens 1355, and a sixth lens 1356. The first to sixth lenses 1351, 1352, 1353, 1354, 1355, and 1356 may be sequentially disposed with respect to an optical axis direction. The first lens 1351 may be referred to as an outermost lens. The first lens 1351 may have a cross-sectional area larger than that of other lenses. A spacer for spacing adjacent lenses may be disposed between the plurality of lenses.

The retainer 1320 may be coupled to an outer surface of the lens barrel 1310. The retainer 1320 and the lens barrel 1310 may be coupled to each other through an epoxy. Unlike this, the retainer 1320 may be screw-coupled to the lens barrel 1310. The retainer 1320 may be coupled to an upper end of the lens barrel 1310. The retainer 1320 may be disposed inside the first body 1100. The incident surface of the first lens 1351 may be protruded upward from an upper surface of the retainer 1320.

The coupling structure between the lens barrel 1310 and the retainer 1320 described above is exemplary, and the camera module may be implemented in an integrated structure in which the lens barrel 1310 and the retainer 1320 are one body.

The retainer 1320 may have a ring-shaped cross section. At least a portion of the retainer 1320 may be disposed to cover an edge of the lens 1350. The retainer 1320 may be disposed to surround an edge of the first lens 1351. The retainer 1320 may be disposed to cover an edge of the incident surface of the first lens 1351. The retainer 1320 may be in contact with a portion of the incident surface of the first lens 1351.

A sealing member coupling groove 1322 to which a sealing member 1620 to be described later is coupled may be formed on an outer surface of the retainer 1320. The sealing member coupling groove 1322 may have a groove shape in which a portion of the outer surface of the retainer 1320 is recessed inward than other regions.

The lens holder 1400 may be disposed inside the first body 1100. The lens holder 1400 may be disposed outside the lens barrel 1310. The lens holder 1400 may have a space formed therein to which the lens barrel 1310 is coupled. A thread or a screw groove may be formed on an inner surface of the lens holder 1400 facing an outer circumferential surface of the lens barrel 1310.

A coupling portion 1420 may be formed on a lower surface of the lens holder 1400 being protruded downward than other regions. A lower surface of the coupling portion 1420 may be in contact with an upper surface of the printed circuit board 1500. A screw hole to which a screw is coupled may be formed on a lower surface of the coupling portion 1420. The lens holder 1400 may be screw-coupled to the printed circuit board 1500 through the screw.

The printed circuit board 1500 may be disposed at a lower portion of the lens module 1300. The printed circuit board 1500 may be disposed inside the second body 1200. The printed circuit board 1500 may be disposed at a lower portion of the lens holder 1400. The printed circuit board 1500 may have a plate shape, and at least one component for driving the camera module may be disposed on upper and lower surfaces thereof. For example, an image sensor 1510 may be disposed on an upper surface of the printed circuit board 1500 facing the lens 1350. The image sensor 1510 may be disposed to face the lens 1350 in an optical axis direction. The image sensor 1510 may be optically aligned with the lens 1350.

A pin 1530 may be disposed on a lower surface of the printed circuit board 1500. The pin 1530 may have a shape being protruded downward from a lower surface of the printed circuit board 1500. At least a portion of the pin 1530 may be disposed inside the connector withdrawal part 1220. The pin 1530 is coupled to an external terminal, and accordingly, power may be supplied to the heating member 1700.

The connector 1520 may be disposed on a lower surface of the printed circuit board 1500. The connector 1520 may be mounted on a lower surface of the printed circuit board 1500. The connector 1520 may be coupled to one end of the heating member 1700. The connector 1520 may be electrically connected to one end of the heating member 1700. The printed circuit board 1500 may be electrically connected to the heating member 1700 through the connector 1520. The connector 1520 may be a BTB connector or an FFC connector.

The printed circuit board 1500 includes a screw hole facing the screw hole of the lens holder 1400, and may be screw-coupled to the lens holder 1400.

The camera module may include sealing members 1610 and 1620. The sealing members 1610 and 1620 may include a first sealing member 1610 being disposed between the first body 1100 and the second body 1200, and a second sealing member 1620 being disposed between an outer surface of the retainer 1320 and an inner surface of the first body 1100. A space inside the camera module may be sealed from an external region through the sealing members 1610 and 1620. The sealing members 1610 and 1620 may have a closed loop-shaped cross section. For example, the second sealing member 1620 may be formed in a ring shape.

Hereinafter, a heat generation structure of a lens according to a second embodiment of the present invention will be described.

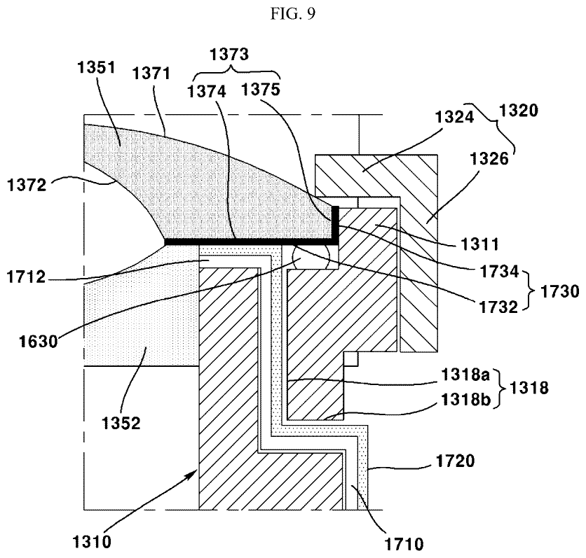

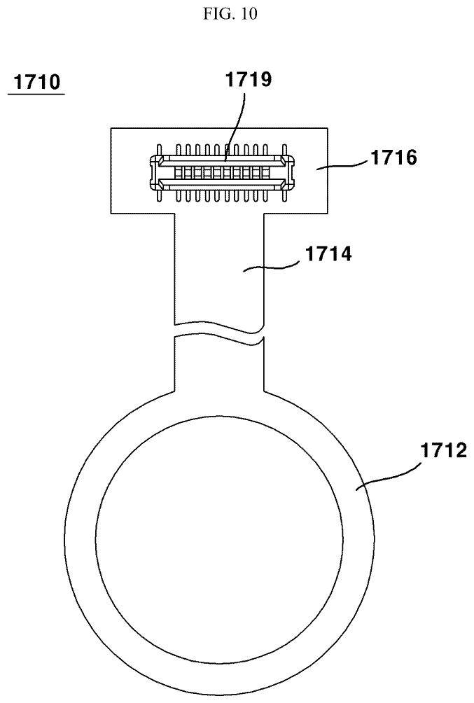

FIG. 9 is a cross-sectional view of a lens heat generation structure according to a second embodiment of the present invention; and FIG. 10 is a plan view of a substrate according to a second embodiment of the present invention.

Referring to FIGS. 9 to 10, a protruded portion 1311 being protruded upward and disposed to surround the first lens 1351 may be disposed on an upper surface of the lens barrel 1310. The protruded portion 1311 may be formed as one body with the lens barrel 1310.

The first lens 1351 may include an incident surface 1371, an exit surface 1372, which faces the incident surface 1371, and a connection surface 1373 connecting the incident surface 1371 to the exit surface 1372. Light incident into the first lens 1351 through the incident surface 1371 may be directed toward the image sensor 1510 through the exit surface 1372.

The connection surface 1373 may include a first surface 1374 facing an upper surface of the second lens 1352 or the lens barrel 1310, and a second surface 1375 facing an inner surface of the protruded portion 1311. The first surface 1374 and the second surface 1375 may be perpendicular to each other. The first surface 1374 may be connected to the exit surface 1372, and the second surface 1375 may be connected to the incident surface 1371.

The retainer 1320 may include an incident surface 1371 and a first region 1324 being disposed on the protruded portion 1311 and a second region 1326 being disposed to surround an outer surface of the lens barrel 1310. The first region 1324 and the second region 1326 may be perpendicular to each other.

The camera module may include a heating member 1700. The heating member 1700 may be a positive temperature coefficient heater (PTC). The heating member 1700 may include a PTC ink 1730 applied to the surface of the first lens 1351, and a substrate 1710 being electrically connected to the PTC ink 1730.

The PTC ink 1730 may be applied to a surface of the first lens 1351. The PTC ink 1730 may be applied to a lower surface of the first lens 1351. The PTC ink 1730 may be applied to the connection surface 1373. The PTC ink 1730 may be applied to the first surface 1374 and the second surface 1375, respectively. The PTC ink 1730 may generate heat by providing power.

The PTC ink 1730 may have a black color. The PTC ink 1730 may be black. Thus, light may be prevented from being reflected from the surface of the lens 1350.

The PTC ink 1730 may be referred to as a heating unit.

One end of the substrate 1710 may be connected to the PTC ink 1730, and the other end thereof may be connected to the printed circuit board 1500. The substrate 1710 may be a flexible circuit board (FPCB). The substrate 1710 may include a region being bent at least once. A circuit pattern 1720 may be formed on a surface of the substrate 1710. The circuit pattern 1720 may be disposed on a surface of the substrate 1710 facing the PTC ink 1730. The circuit pattern 1720 may be a metal paste.

As illustrated in FIG. 10, the substrate 1710 may include an upper end portion 1712, a lower end portion 1716, and a connecting portion 1714. The upper end portion 1712 has a ring-shaped cross section and may be connected to the PTC ink 1730. The upper end portion 1712 may be in contact with a portion of the lower surface of the PTC ink 1730. The lower end portion 1716 may be connected to the printed circuit board 1500. The lower end portion 1716 may be coupled to the connector 1520. The connecting portion 1714 is disposed to connect the upper end portion 1712 and the lower end portion 1716 and may have a region being bent at least once. At least a portion of the connecting portion 1714 may be disposed in the hole 1318 inside the lens barrel 1310 to be described later.

Meanwhile, the lens barrel 1310 may include a hole 1318 through which the substrate 1710 penetrates. The substrate 1710 may be disposed to penetrate the hole 1318. The hole 1318 may include a plurality of regions perpendicular to one another. The hole 1318 may include a first hole 1318a and a second hole 1318b. The first hole 1318a and the second hole 1318b communicate with each other and may be vertically disposed.

A sealing member 1630 may be disposed between the first lens 1351 and an upper surface of the lens barrel 1310. Through the sealing member 1630, foreign substances may be prevented from being introduced between the lens barrel 1310 and the first lens 1351.

According to the above structure, there is an advantage in that frost or ice formation generated on the surface of the lens may be quickly removed through heat generated from the heating member.

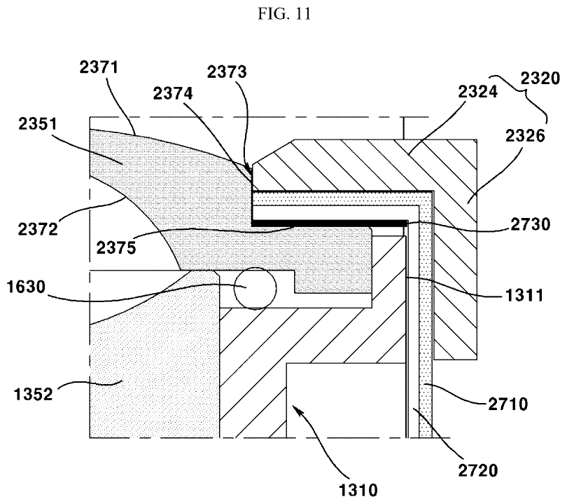

FIG. 11 is a cross-sectional view of a lens heat generation structure according to a third embodiment of the present invention.

In the present embodiment, other parts are the same as those of the second embodiment, but there is a difference according to the arrangement structure of the heating member. Therefore, hereinafter, only characteristic parts of the present embodiment will be described, and the description of the second embodiment will be referred to in the remaining parts.

Referring to FIG. 11, a protruded portion 1311 being protruded upward and disposed to surround the first lens 1351 may be disposed on an upper surface of the lens barrel 1310. The truncated region 1311 may be formed as one body with the lens barrel 1310.

The first lens 2351 may comprise an incident surface 2371, an exit surface 2372 facing the incident surface 2371, and a connection surface 2373 connecting the incident surface 2371 to the exit surface 2372. The connection surface 2373 may be formed on a side surface of the first lens 2351. The connection surface 2373 may be covered by a retainer 2320.

The connection surface 2373 may include a first surface 2374 being disposed to face the retainer 2320 in a direction perpendicular to the optical axis direction, and a second surface 2375 being disposed to face the retainer 2320 in an optical axis direction. The first surface 2374 and the second surface 2375 may be perpendicular to each other. The first surface 2374 may be connected to the incident surface 2371. The second surface 2375 may be disposed at an edge of the upper surface of the first lens 2351.

The retainer 2320 may include a first region 2324 being disposed on the lens barrel 1310 and a second region 2326 being disposed to surround a side surface of the lens barrel 1310. The first region 2324 and the second region 2326 may be perpendicular to each other. The first region 2324 may be disposed to be overlapped with the second surface 2375 in an optical axis direction. The first region 2324 may be in contact with the first surface 2374.

The heating member may include a PTC ink 2730 being disposed on the second surface 2375, and a substrate 2710 electrically connected to the PTC ink 2730.

The PTC ink 2730 may be applied to the surface of the first lens 2351. The PTC ink 2730 may be applied to an upper surface of the first lens 2351. The PTC ink 2730 may be applied to the second surface 2375 of the connection surface 2373. The PTC ink 2730 may generate heat by providing power.

The PTC ink 2730 may be referred to as a heating unit.

The substrate 2710 may have one end connected to the PTC ink 2730 and the other end connected to the printed circuit board 1500. The substrate 2710 may be a flexible circuit board (FPCB). The substrate 2710 may include a region bent at least once. A circuit pattern 2720 may be formed on a surface of the substrate 2710. The circuit pattern 2720 may be disposed on a surface of the substrate 2710 facing the PTC ink 2730.

At least a portion of the substrate 2710 may be disposed between the lens barrel 1310 and the retainer 2320. A separation portion may be formed between an outer surface of the lens barrel 1310 and an inner surface of the retainer 2320 so that the substrate 2710 penetrates therethrough. The separation portion may have a hole shape.

A sealing member 1630 may be disposed between the lower surface of the first lens 2351, that is, the exit surface of the first lens 2351 and the upper surface of the lens barrel 1310. Foreign substances may be prevented from being introduced between the lens barrel 1310 and the first lens 2351 through the sealing member 1630. Meanwhile, in the present embodiment, since the sealing member 1630 may be supported by the outer surface of the second lens 1352, there is an advantage in that a space inside the module may be secured more widely.

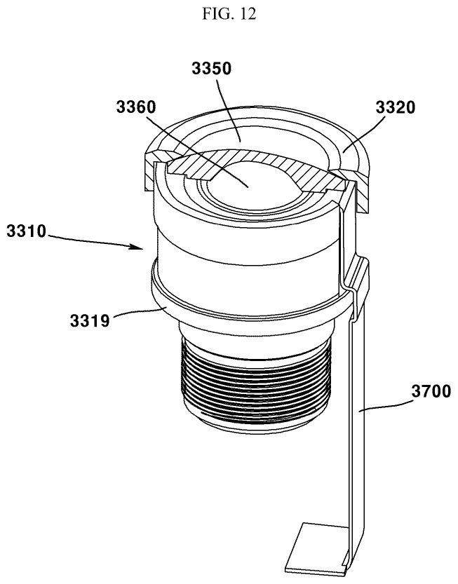

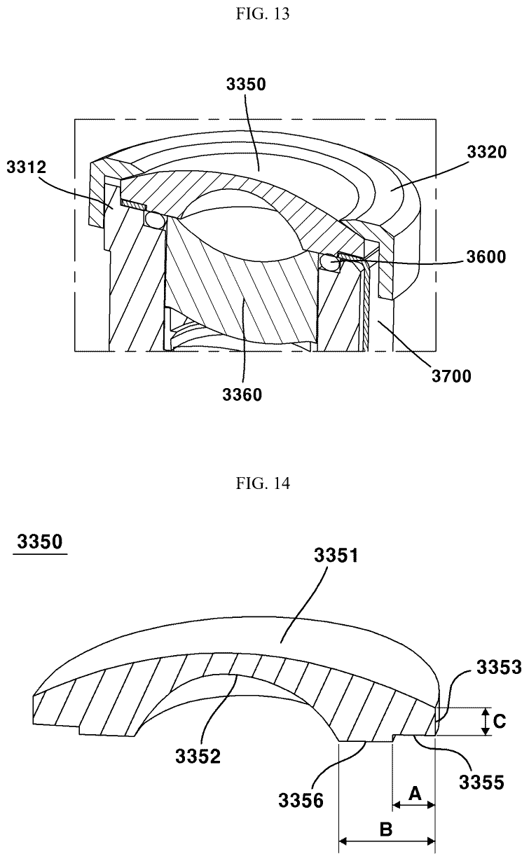

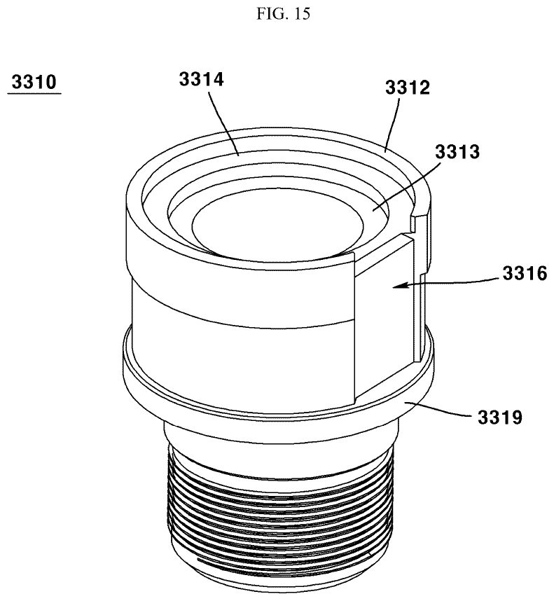

FIG. 12 is a perspective view of a camera module according to a fourth embodiment of the present invention; FIG. 13 is a cross-sectional view of a camera module according to a fourth embodiment of the present invention; FIG. 14 is a cross-sectional view of a first lens according to a fourth embodiment of the present invention; and FIG. 15 is a perspective view of a lens barrel according to a fourth embodiment of the present invention.

In the present embodiment, other parts are the same as those of the second embodiment, but there is a difference according to the arrangement structure of the heating member. Therefore, hereinafter, only characteristic parts of the present embodiment will be described, and the description of the above-described embodiment will be referred to in the remaining parts.

Referring to FIGS. 12 to 15, the camera module according to the present embodiment may include a lens barrel 3310, a lens, a retainer 3320, and a heating member 3700.

The lens barrel 3310 may include a space in which the lens is accommodated. A protruded portion 3312 protruding upward may be formed on an upper surface of the lens barrel 3310. The protruded portion 3312 may support the side surfaces of the first lens 3350.

A flange 3319 may be formed on a side surface of the lens barrel 3310. With respect to the flange 3319, the lens barrel 3310 may be divided into a first region and a second region. The first region may be disposed on an upper portion of the flange 3319, and the second region may be disposed on a lower portion of the flange 3319. A cross-sectional area of the first region may be larger than a cross-sectional area of the second region. The second region may be screw-coupled to a lens holder 1400 (see FIG. 8).

A first surface 3314 and a second surface 3313 may be formed on an upper surface of the lens barrel 3310. The first surface 3314 and the second surface 3313 may be stepped in an optical axis direction. The first surface 3314 may be disposed outside the second surface 3313. The first surface 3314 may be disposed at an upper side of the second surface 3313. An upper surface of the protruded portion 3312 may be disposed at an upper side of the first surface 3314.

An avoidance portion 3316 may be formed on a side surface of the lens barrel 3310. The avoidance portion 3316 may have a groove shape being recessed inwardly than other regions. The avoidance portion 3316 may be formed on a side surface of the first region. An upper surface of the avoidance portion 3316 may be disposed at an upper side of the first surface 3314, and may be disposed at a lower side of the upper surface of the truncated port 3312.

A lens may be disposed in the lens barrel 3310. The lens may include a first lens 3350 and a second lens 3360. The first lens 3350 and the second lens 3360 may be disposed vertically with respect to an optical axis direction. The first lens 3350 may be an outermost lens. An incident surface 3351 of the first lens 3350 may be disposed at an upper side of the upper surface of the lens barrel 3310.

The first lens 3350 may include an incident surface 3351 through which light is incident, an exit surface 3352 through which light is emitted, and a plurality of connection surfaces 3353 and 3355. The plurality of connection surfaces 3353 and 3355 may connect the incident surface 3351 to the exit surface 3352, and may include a first connection surface 3353 and a second connection surface 3355. The first connection surface 3353 may form a side surface of the first lens 3350. The second connection surface 3355 may form a lower surface of the first lens 3350. The second connection surface 3355 may include a protruding area 3356 being protruded downward. The protruding area 3356 may be connected to the exit surface 3352.

When the first lens 3350 is viewed from below, the second connection surface 3355 except for the protruding area 3356 may have a groove shape. Accordingly, the lower surface of the protruding area 3356 may be referred to as a second connection surface, and the second connection surface 3355 may be referred to as a groove, with respect to the lower surface of the first lens 3350.

With respect to a direction perpendicular to the optical axis direction, the length A of the second connection surface 3355 excluding the protruding area 3356 may be less than ⅔ of the length B of the protruding area 3356.

The length C of the first connection surface 3353 may be greater than or equal to 0.5 mm with respect to the optical axis direction.

The retainer 3320 may be disposed on the lens barrel 3310 and may support the first lens 3350. The retainer 3320 may be disposed to surround an outer surface of the lens barrel 3310. A hole for exposing the first lens 3350 may be formed at a center of the retainer 3320.

The heating member 3700 may have one end disposed on a lower surface of the first lens 3350, and the other end connected to the printed circuit board. The heating member 3700 may include a heating part, and the heating part may be in contact with the second connection surface 3355 except for the protruding region 3356. The heating part may have a lower surface supported by the first surface 3314 of the lens barrel 3310.

At least a portion of the connecting part of the heating member 3700 may be disposed in the avoidance portion 3316.

The camera module includes a sealing member 3600, and the sealing member 3600 may be disposed between a lower surface of the protruding area 3356 and the second surface 3313. The sealing member 3600 may be supported by a side surface of the second lens 3360.

In the above description, it is described that all the components constituting the embodiments of the present invention are combined or operated in one, but the present invention is not necessarily limited to these embodiments. In other words, inside the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas inside the equivalent scope should be interpreted as being included in the scope of the present invention.

1. A camera module comprising:
a lens barrel;
a lens disposed inside the lens barrel;
a heating member including a heating unit disposed on a surface of the lens; and
a sensor member including a sensor unit disposed on a lower surface of the heating unit,
wherein the lens includes a groove to which the heating unit and the sensor unit are coupled.

2. The camera module according to claim 1,
wherein the heating unit is a positive temperature coefficient (PTC) ink applied to a surface of the lens.

3. The camera module according to claim 1,
wherein the heating unit has a black color.

4. The camera module according to claim 1,
wherein each of the heating unit and the sensor unit has a ring-shaped cross-section.

5. The camera module according to claim 4,
wherein a temperature sensor is disposed on a lower surface of the sensor unit.

6. The camera module according to claim 1,
wherein the heating unit and the sensor unit are interposed between an upper surface of the lens barrel and a lower surface of the lens.

7. The camera module according to claim 1,
wherein a rib protruded downward is disposed on a lower surface of the sensor unit.

8. The camera module according to claim 1,
wherein the heating member includes a first connecting portion having one end connected to the heating unit and another end connected to a printed circuit board,
wherein the sensor member includes a second connecting portion having one end connected to the sensor unit and another end connected to the printed circuit board, and
wherein the first connecting portion and the second connecting portion are disposed to be overlapped with at least a portion thereof.

9. The camera module according to claim 8,
wherein the first connecting portion and the second connecting portion are flexible printed circuit boards (FPCBs).

10. The camera module according to claim 8, wherein an avoidance portion is arranged on a side of the lens barrel to which the first connecting portion and the second connecting portion are connected.

11. The camera module according to claim 10, wherein the avoidance portion includes a bottom surface and a plurality of guide surfaces arranged on both sides of the bottom surface, and
wherein the guide surfaces and the bottom surface form an obtuse angle with each other.

12. The camera module according to claim 7, wherein the rib contacts an upper surface of the lens barrel.

13. The camera module according to claim 1, wherein the heating member includes a first terminal portion,
wherein the sensor member includes a second terminal portion, and
wherein a printed circuit board to which the first terminal portion is coupled and a printed circuit board to which the second terminal portion is coupled are different from each other.

14. The camera module according to claim 1, wherein the lens includes an incident surface through which light is incident, an exit surface through which light is emitted, and a connecting surface connecting the incident surface and the exit surface, and
wherein the groove is arranged on the connecting surface.

15. The camera module according to claim 14, wherein the connecting surface includes a second connecting surface that is stepped in a direction of an optical axis with the groove.

16. A camera module comprising:
a first body;
a lens module disposed inside the first body, the lens module including a lens barrel and a lens disposed inside the lens barrel;
a printed circuit board disposed inside the first body; and
a heating member configured to provide heat to the lens,
wherein the heating member includes a heating unit disposed on a surface of the lens, and a substrate electrically connecting the heating unit and the printed circuit board.

17. The camera module according to claim 16, wherein the lens includes a groove to which the heating member is coupled.

18. The camera module according to claim 17, comprising a sensor member including a sensor unit disposed on a lower surface of the heating member.

19. The camera module according to claim 17, wherein the lens includes an incident surface through which light is incident, an exit surface through which light is emitted, and a connecting surface connecting the incident surface and the exit surface, and
wherein the groove is arranged on the connecting surface.

20. The camera module according to claim 19, wherein the connecting surface includes a second connecting surface that is stepped in a direction of an optical axis with the groove.
